(19) United States
(12) Patent Application Publication
(10) Pub. No.: US 2016/0178834 A1
(43) Pub. Date: Jun. 23, 2016

(54) DISPLAY APPARATUS AND BACK LIGHT MODULE THEREOF

(71) Applicant: Innolux Corporation, Miao-Li County (TW)

(72) Inventors: Chiao-Fu Yu, Miao-Li County (TW); Fu-Chi Hu, Miao-Li County (TW); Meng-Chieh Chang, Miao-Li County (TW)

(21) Appl. No.: 14/944,260

(22) Filed: Nov. 18, 2015

Related U.S. Application Data
(60) Provisional application No. 62/092,853, filed on Dec. 17, 2014.

(30) Foreign Application Priority Data
Jun. 10, 2015 (TW) 104118741

(51) Int. Cl. F21V 8/00

(52) U.S. Cl. CPC G02B 6/0076; G02B 6/0055; G02B 6/0056; G02B 6/0065; G02B 6/0063

(57) ABSTRACT

A back light module is provided. The back light module includes a first light emitting module, a second light emitting module and an attenuator. The first light emitting module has a light output surface. The second light emitting module is disposed on one side of the first light emitting module opposite to the light output surface. The attenuator is disposed between the first light emitting module and the second light emitting module, and includes a first polarizer having a first absorption axis.

This application claims the benefit of U.S. provisional application Ser. No. 62/092,853, filed Dec. 17, 2014, and the benefit of Taiwan application Serial No. 104118741, filed Jun. 10, 2015, the subject matters of which are incorporated herein by reference.

### BACKGROUND OF THE INVENTION

1. Field of the Invention

The invention relates in general to a display apparatus and a back light module thereof, and more particularly to a 2D/3D switchable display apparatus and a back light module thereof.

2. Description of the Related Art

In general, three dimensional (3D) displays can be classified into stereoscopic type 3D display and autostereoscopic type 3D display. The autostereoscopic type 3D display is a 3D display apparatus applying a special optical element, such as parallax barrier or a lenticular lens for enabling the user's left eye and right eye to respectively receive the parallactic images provided by the 3D display apparatus, so as to make the user perceiving a 3D image. In order to satisfy the user's requirement for viewing a two dimensional (2D) image, a 2D/3D switchable display apparatus is provided. The 2D/3D switchable display apparatus allows the user to switch between 3D display mode and 2D display mode.

Typically, a 2D/3D switchable display apparatus includes a 3D light emitting module and a 2D light emitting module. When the 3D display mode is enabled, the 2D light emitting module can be turned off and only the 3D light emitting module emits the light. When the light emitted from the 3D light emitting module passes through an image display panel, such as a liquid crystal display panel (LCD), parallactic images are generated and received by the user's left eye and right eye respectively, such that the user can perceive a 3D image. When the 2D display mode is enabled, the 2D light emitting module is turned on and the 3D light emitting module can be either turned off or maintained at a partial on state to supplement the light, and after the light provided from the 2D light emitting module passing through the 3D light emitting module and the image display panel, the user can perceive a 2D image.

However, during the enabling of the 3D display mode, a part of the light emitted from the 3D light emitting module does not directly pass through the image display panel. Instead, the part of the light is firstly emitted to the 2D light emitting module, and then is further reflected to the user's eyes from the 2D light emitting module, unexpected moirés having a staggered arrangement of bright and dark stripes are thus formed and crosstalking with the 3D image displayed on the display panel. As a result, the display quality of 3D image display apparatus is reduced.

Therefore, it has become a prominent task for the industries to provide an advanced display apparatus and a back light module thereof to obviate the drawbacks encountered in the prior art.

### SUMMARY OF THE INVENTION

One embodiment of the description is directed to a back light module including a first light emitting module, a second light emitting module and an attenuator. The first light emitting module has a light output surface. The second light emitting module is disposed on one side of the first light emitting module opposite to the light output surface. The attenuator includes a first polarizer having a first absorption axis, and the first polarizer is disposed between the first light emitting module and the second light emitting module.

One embodiment of the description is directed to a display apparatus including a display panel and a back light module. The display panel includes a lower polarizer and an upper polarizer disposed at opposite side of the lower polarizer, and the lower polarizer and the upper polarizer respectively have a first polarization axis and a second polarization axis orthogonal to each other. The back light module includes a first light emitting module, a second light emitting module and an attenuator. The first light emitting module has a light output surface facing to the lower polarizer. The second light emitting module is disposed on one side of the first light emitting module opposite to the light output surface. The attenuator is disposed between the first light emitting module and the second light emitting module, and includes a first polarizer having a first absorption axis substantially parallel to the first polarization axis of the lower polarizer.

Another embodiment of the description is directed to a back light module including a first light emitting module, a second light emitting module, a reflector and an attenuator. The first light emitting module has a light output surface. The reflector is disposed on one side of the first light emitting module opposite to the light output surface. The second light emitting module is disposed between the first light emitting module and the reflector. The attenuator includes a polarizer and a retardation plate. The polarizer has an absorption axis, and is disposed between the second light emitting module and the reflector. The retardation plate is disposed between polarizer and the reflector.

Another embodiment of the description is directed to a display apparatus including a display panel and a back light module. The back light module includes a first light emitting module, a reflector, a second light emitting module and an attenuator. The first light emitting module has a light output surface facing to the display panel. The reflector is disposed on one side of the first light emitting module opposite to the light output surface. The second light emitting module is disposed between the first light emitting module and the reflector. The attenuator includes a polarizer and a retardation plate. The polarizer has an absorption axis, and is disposed between the second light emitting module and the reflector. The retardation plate is disposed between the polarizer and the reflector.

In accordance with the embodiments of the present description, a 2D/3D switchable display apparatus and a back light module thereof are provided. In some embodiments of the invention, the back light module of the display apparatus at least includes a first light emitting module and a second light emitting module disposed in parallel. By switching between the first light emitting module and the second light emitting module, at least a 2D display mode and a 3D display mode can be provided to allow the users perceiving either 2D images or 3D images from the 2D/3D switchable display apparatus. The first light emitting module has a light output surface, and an attenuator having at least one absorption polarizer is disposed on one side of the first light emitting module opposite to the light output surface. The attenuator can prevent a small part of the light that is emitted from the first light emitting module and towards the second light emitting module from being reflected by the second light emitting module and forming unexpected moirés having a staggered arrangement of bright and dark stripes, so as to avoid the small part of the light crosstalking with the major part of light that is emitted from the first light emitting module and directly passing through the light output surface. Thus, the display quality of the display apparatus can be improved when the first light emitting module is enabled, and the display quality of the display apparatus may not be affected when switched to another display mode.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A is a cross-sectional view illustrating the structure of a back light module according to an embodiment of the invention;

FIG. 1B is an enlarged cross-sectional view illustrating a partial structure of the attenuator as depicted in FIG. 1A;

FIG. 2A is a cross-sectional view illustrating the structure of a back light module according to another embodiment of the invention;

FIG. 2B is an enlarged cross-sectional view of a partial structure of the attenuator as depicted in FIG. 2A;

FIG. 3A is a cross-sectional view illustrating the structure of a back light module according to another embodiment of the invention;

FIG. 3B is an enlarged cross-sectional view illustrating a partial structure of the attenuator as depicted in FIG. 3A;

FIG. 4A is a cross-sectional view illustrating the structure of a back light module according to another embodiment of the invention;

FIG. 4B is a cross-sectional view of the structure illustrating a back light module according to another embodiment of the invention;

FIG. 4C is an enlarged cross-sectional view illustrating a partial structure of the attenuator as depicted in FIG. 4A and FIG. 4B;

FIG. 5 is a cross-sectional view illustrating the structure of a display apparatus according to an embodiment of the invention; and

FIG. 6 is a cross-sectional view of the structure illustrating a display apparatus according to another embodiment of the invention.

### DETAILED DESCRIPTION OF THE INVENTION

The invention provides a back light module including two light emitting modules, and a display apparatus using the same. The invention resolves the problem of image crosstalk caused by light reflection occurring between the two light emitting modules, and improves the display quality of the display apparatus. To make the objects, technical features and advantages of the invention more apparent and easily understood, a number of exemplary embodiments are exemplified below with accompanying drawings.

It should be noted that the implementations and methods disclosed in the present invention are not for limiting the invention. The invention still can be implemented by using other features, elements methods and parameters. Exemplary embodiments are provided for illustrating the technical features of the invention, not for limiting the scope of protection of the invention. Any persons ordinarily skilled in the art can make suitable modifications and adjustments based on the description of the specification without breaching the spirit of the invention. Common reference designations are used throughout the drawings and embodiments to indicate the same elements.

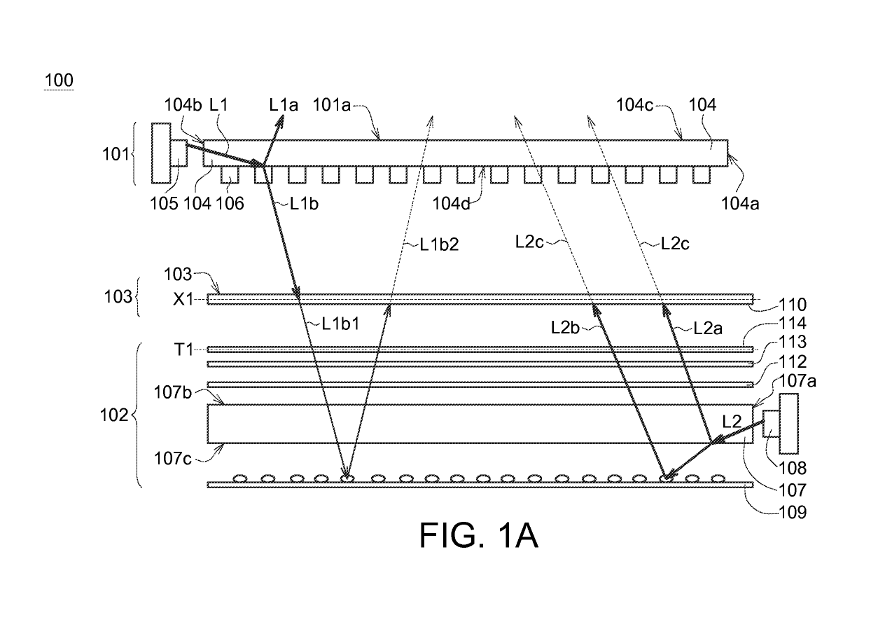

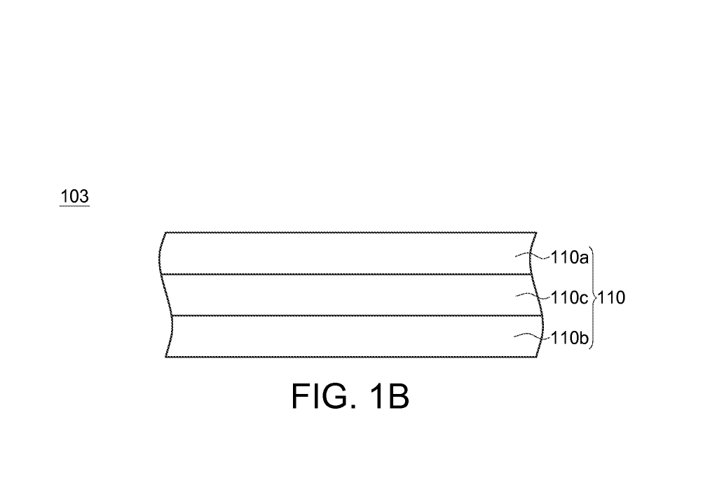

FIG. 1A is a cross-sectional view illustrating the structure of a back light module 100 according to an embodiment of the invention. The back light module 100 includes a first light emitting module 101, a second light emitting module 102 and an attenuator 103. In some embodiments of the invention, the first light emitting module 101 is disposed above the second light emitting module 102, and the attenuator 103 is disposed between the first light emitting module 101 and the second light emitting module 102. In detail, the first light emitting module 101 is a light emitting and light permeable structure mainly used in a 3D mode displaying and has a light output surface 101a. The light L1 emitted from the first light emitting module 101 is exited via the light output surface 101a to a display panel for 3D image. The second light emitting module 102, mainly used in 2D mode displaying is disposed on one side of the first light emitting module 101 opposite to the light output surface 101a. After emitted from the second light emitting module 102 and passing through the second light emitting module 102, the light L2 is exited via the light output surface 101a of the first light emitting module 101 to the display panel for 2D image. The light output surface 101a is a terminal surface of the light emitted from the back light module 100. Of the optical elements in the first light emitting module of the present embodiment, the light output surface 101a is the surface nearest to the display panel and observer.

In some embodiments of the invention, the first light emitting module 101 may include a light guide plate 104, at least one light emitting unit 105 and a plurality of light guide elements 106. The light guide plate 104 has at least one light input surface 104a (or 104b), a first side surface 104c and a second side surface 104c opposite to the first side surface 104c. The light guide plate 104 can be formed of glass, polymethylmethacrylate (PMMA) or other possible light permeable material (but not limited thereto). The light emitting unit 105 is disposed adjacent to the light input surface 104a (or 104b). In the present embodiment, the light emitting unit 105 is disposed adjacent to the light input surface 104b. In other embodiments, there can be two light emitting units 105 respectively disposed adjacent to the light input surfaces 104a and 104b. A plurality of light guide elements 106 is disposed on at least one of the first side surface 104c and the second side surface 104d.

In the present embodiment, the first light emitting module 101 is an edge-lite light emitting module and has a plurality of light emitting units 105 adjacent to the light input surfaces 104a and 104b parallel to the thickness direction of the light guide plate 104. The first side surface 104c perpendicular to the thickness direction of the light guide plate 104 can be used as the light output surface 101a of the first light emitting module 101. In other words, the first side surface 104c is the surface of the back light module 100 nearest to the display panel and the observer, and is also the upper surface of the light guide plate 104. The light guide elements 106 is disposed on the second side surface 104d opposite to the first side surface 104c, that is, on the lower surface of the light guide plate 104. In other embodiments, the light guide elements 106 can be either only disposed on the first side surface 104c or both disposed on the first side surface 104c and the second side surface 104d.

In some embodiments of the invention, the light guide elements 106 can be realized by regular or irregular protrusions, ribs, slots, openings, or recesses. The cross section of each light guide elements 106 (viewed from a direction parallel to the first side surface 104c and the second side surface 104c) can be an arc, a polygon (including triangle, square, rectangle, trapezoid, and polygon) or an irregular shape, so that the total reflection effect of the light guide plate 104 can be destroyed, and the light can be reflected or scattered by the light guide elements 106 and then is exited via the light output surface 101a (that is, the first side surface 104c of the light guide plate 104). In some embodiments, the light guide elements 106 can be arranged to form a stripe pattern having a plurality of stripes with a predetermined distribution. Through the distribution of stripes, the light L1a reflected or scattered by the light guide elements 106 can form a barrier pattern having different light output intensities in different areas (such as bright areas and dark areas). Therefore, most of the light L1a emitted from the light emitting unit 105 and entering into the light guide plate 104 can be guided to the display panel with an alternating pattern of light and shade by the light guide elements 106 to display a 3D image.

The second light emitting module 102 may include a light guide plate 107, at least one light emitting unit 108 and a reflector 109. The light guide plate 107 is disposed between the reflector 109 and the light guide plate 104 of the first light emitting module 101, and has at least one light input surface 107a, and a third side surface 107b and a fourth side surface 107c opposite to the third side surface 107b. The light emitting unit 108 is disposed adjacent to the light input surface 107a. The third side surface 107b of the light guide plate 107 faces to the second side surface 104d of the light guide plate 104 of the first light emitting module 101. The reflector 109 is formed of a white scattering material and faces to the fourth side surface 107c of the light guide plate 107. A major part of the light L2 emitted from the light emitting unit 108 and entering the light guide plate 107 that is designated as L2a may directly pass through the first light emitting module 101, and the other part of the light L2 (designated as L2b) is reflected by the reflector 109 and then passes through the second light emitting module 102 and the first light emitting module 101 to be exited via the light output surface 101a of the first light emitting module 101 (i.e. the first side surface 104c of the light guide plate 104 of the first light emitting module 101) to form a surface light source.

The attenuator 103 is disposed between the first light emitting module 101 and the second light emitting module 102. In some embodiments of the invention, the attenuator 103 at least includes an absorption line polarizer, such as the first polarizer 110 having a first absorption axis X1. In the present embodiment, the attenuator 103 can be formed by one single first polarizer 110. Referring to FIG. 1B, FIG. 1B is an enlarged cross-sectional view illustrating a partial structure of the attenuator 103 as depicted in FIG. 1A. The first polarizer 110 includes a first base layer 110a, a second base layer 110b and a polarizing layer 110c (poly-vinyl alcohol, PVA) interposed between the first base layer 110a and the second base layer 110b. In some embodiment, the polarizing layer 110c is made of materials with extension and light absorption. Through arranging the extension and absorption of the materials, the polarizing layer 110c can have light absorption anisotropic function and achieve polarization effect. The first base layer 110a and the second base layer 110b can be formed of the same or different materials. The first base layer 110a and the second base layer 110b can be formed of a material selected from a group composed of triacetate cellulose (TAC), polymethylmethacrylate (PMMA), polyethylene terephthalate (PET) and the arbitrary combinations thereof.

To avoid affecting the light of the first light emitting module 101 being exited via the light output surface 101a, in some embodiments of the invention, a certain space is created between the attenuator 103 and the first light emitting module 101. In other words, the attenuator 103 does not directly contact with the first light emitting module 101. In the present embodiment, an air layer is interposed between the first polarizer 110 of the attenuator 103 and the light guide elements 106 of the first light emitting module 101, so that the first polarizer 110 of the attenuator 103 and the light guide elements 106 of the first light emitting module 101 will not have direct contact.

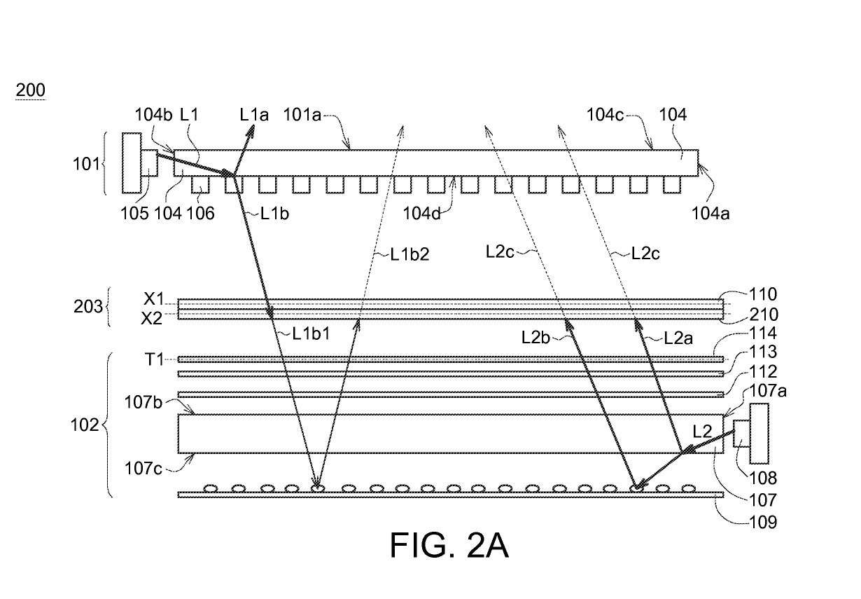

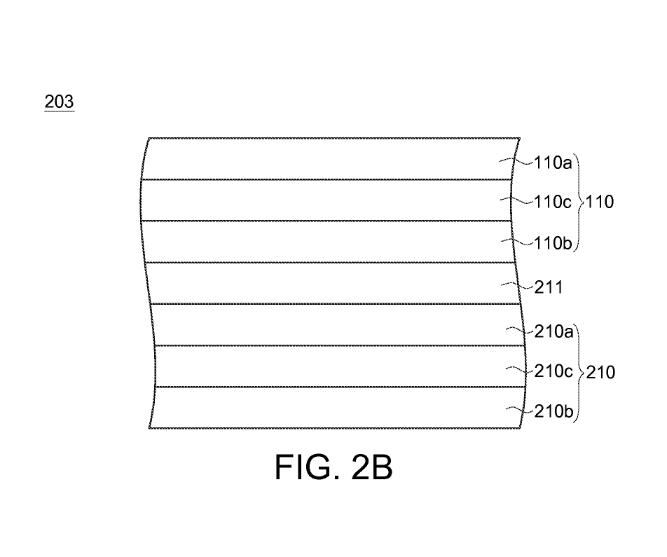

In order to increase product reliability of the attenuator and avoid the first polarizer 110 being warped after assembly, in some embodiments of the invention, the attenuator can be realized by a multi-layer structure composed of at least two polarizers, and the absorption axes of the polarizers are substantially parallel to each other. Referring to FIG. 2A, FIG. 2A is a cross-sectional view illustrating the structure of a back light module 200 according to another embodiment of the invention. The structure of the back light module 200 is similar to that of the back light module 100 as depicted in FIG. 1A except that the attenuator 203 further includes at least a second polarizer 210 disposed between the second light emitting module 102 and the first polarizer 110 in addition to the first polarizer 110. That is, the first polarizer 110 is disposed above the second polarizer 210. The second polarizer 210 has a second absorption axis X2 substantially parallel to the first absorption axis X1 of the first polarizer 110. In another embodiment of the invention, the second polarizer 210 can be disposed between the first light emitting module 101 and the first polarizer 110. That is, the second polarizer 210 is disposed above the first polarizer 110.

Referring to FIG. 2B, FIG. 2B an enlarged cross-sectional view illustrating a partial structure of the attenuator 203 as depicted in FIG. 2A. In the present embodiment, the attenuator 203 is a bi-layer structure composed of the first polarizer 110, the second polarizer 210 and an adhesive layer 211 interposed between the first polarizer 110 and the second polarizer 210. The second polarizer 210 includes a third base layer 210a, a fourth base layer 210b and a PVA layer 210c interposed between the third base layer 210a and the fourth base layer 210b. The third base layer 210a and the fourth base layer 210b can be formed of the same or different materials. The third base layer 210a and the fourth base layer 210b can be formed of a material selected from a group composed of TAC, PMMA, PET and the arbitrary combinations thereof. The adhesive layer 211 can be formed of a light permeable pressure sensitive adhesive (PSA) or other possible light permeable adhesive. Since the warping directions of the strengths of the first polarizer 110 and the second polarizer 210 are opposite to each other and can therefore offset their deformations, thus the attenuator 203 having two polarizers disposed at two opposite sides has a smaller deformation than the attenuator 103 having only one polarizer.

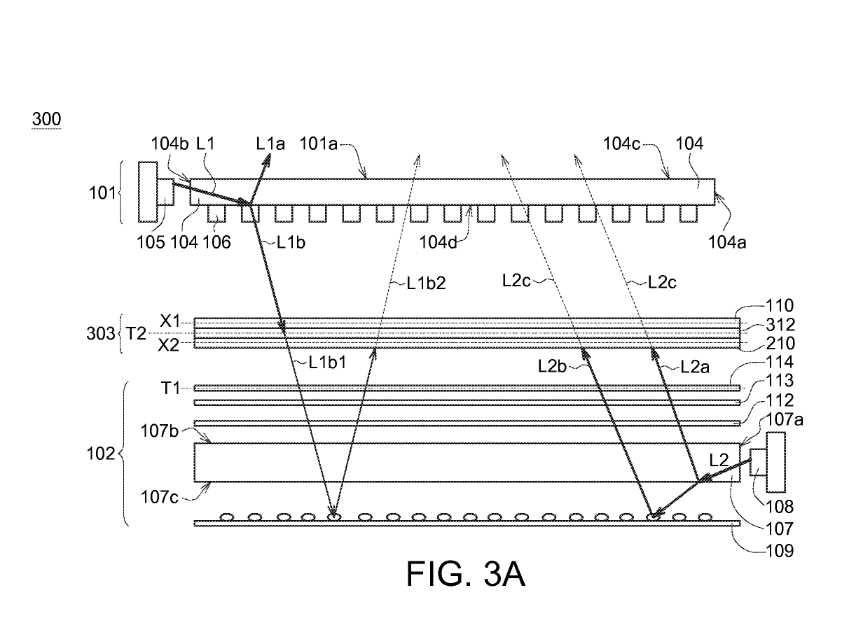

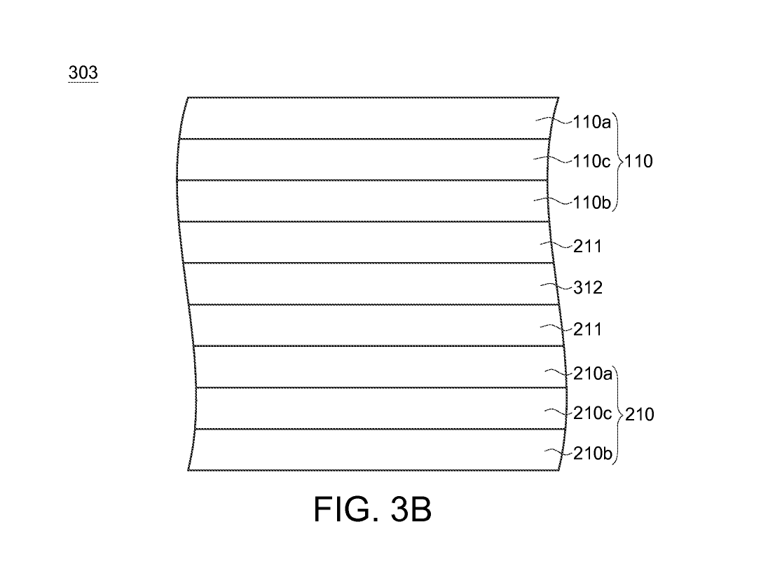

In some embodiments of the invention, the attenuator may further include at least one optical film interposed between the first polarizer 110 and the second polarizer 210. Refer to FIG. 3A and FIG. 3B. FIG. 3A is a cross-sectional view illustrating the structure of a back light module 300 according to another embodiment of the invention. FIG. 3B is an enlarged cross-sectional view illustrating a partial structure of the attenuator 303 as depicted in FIG. 3A. The structure of the back light module 300 is similar to that of the back light module 200 as depicted in FIG. 2A except that the attenuator 303 further includes an optical film 312 composed of a diffuser, a brightness enhancement film (BEF), a reflective polarizer brightness enhancement film (also called dual brightness enhancement film, DBEF) or one of the arbitrary combinations thereof. The optical film 312 is interposed between the first polarizer 110 and the second polarizer 210, and is respectively bonded with the first polarizer 110 and the second polarizer 210 through the adhesive layer 211.

It should be noted that if the optical film 312 interposed between the first polarizer 110 and the second polarizer 210 is a reflective polarizer brightness enhancement film, then the light penetration axis T3 of the optical film 312 must be substantially parallel to the first absorption axis X1 of the first polarizer 110 and the second absorption axis X2 of the second polarizer 210.

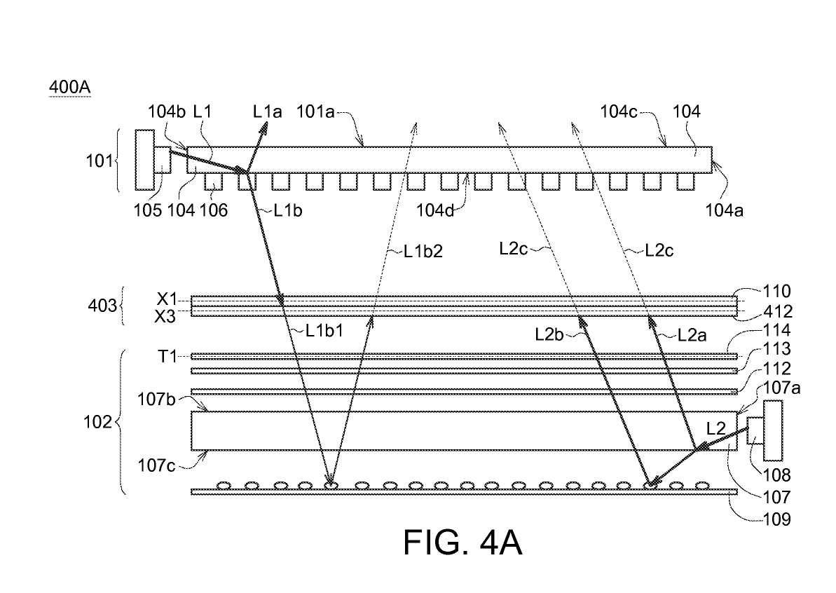

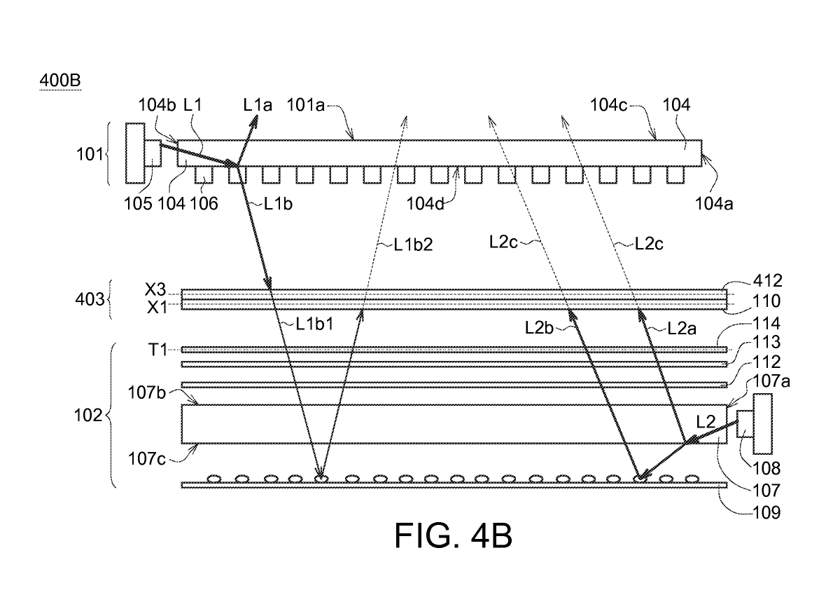

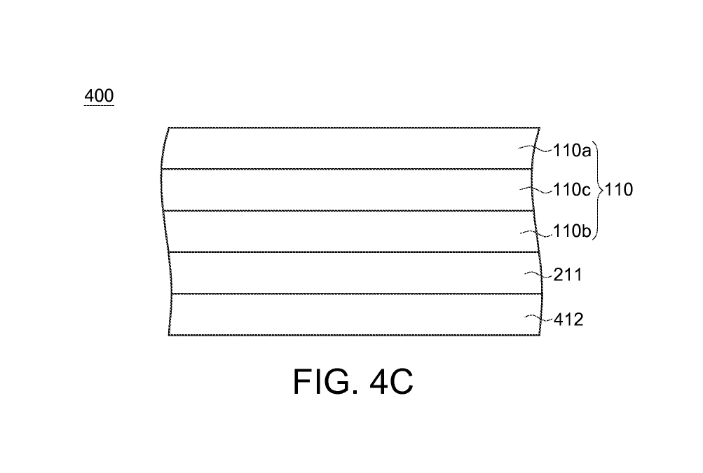

In some embodiments of the invention, the attenuator may further include at least one optical film disposed between one of the first light emitting module 101 and the second light emitting module 102 and the attenuator. Refer to FIG. 4A to FIG. 4C. FIG. 4A is a cross-sectional view of the structure illustrating a back light module 400A according to another embodiment of the invention. FIG. 4B is a cross-sectional view illustrating the structure of a back light module 400B according to another embodiment of the invention. FIG. 4C is an enlarged cross-sectional view illustrating a partial structure of the attenuator 403 as depicted in FIG. 4A and FIG. 4B. The structure of the back light module 400A is similar to that of the back light module 200 as depicted in FIG. 2A except that the attenuator 403 further includes an optical film 412 in addition to the first polarizer 110. The optical film 412 is composed of a diffuser, a brightness enhancement film, a reflective polarizer brightness enhancement film or one of the arbitrary combinations thereof, and is disposed between the second light emitting module 102 and the first polarizer 110. That is, the optical film 412 is disposed above the first polarizer 110. The structure of the back light module 400B is similar to that of the back light module 400A except that the disposition of the attenuator 403 is different from that of the back light module 400A. In the back light module 400B, the optical film 412 of the attenuator 403 is disposed between the first light emitting module 101 and the first polarizer 110. That is, the optical film 412 is disposed under the first polarizer 110.

In order to increase the light extraction rate for the second light emitting module 102, preferably at least one optical film 112 composed of the diffuser 112, the brightness enhancement film 113, the reflective polarizer brightness enhancement film 114 or one of the arbitrary combinations thereof, may be disposed between the second light emitting module 102 and the attenuators 103, 203 and 303 (as indicated in FIG. 1A, FIG. 2A, FIG. 3A, FIG. 4A and FIG. 4B). In some embodiments of the invention, at least one optical film (not illustrated) can be disposed between the first light emitting module 101 and the attenuators 103, 203 and 303. It should be noted that the reflective polarizer brightness enhancement film 114 disposed between the first light emitting module 101 and the second light emitting module 102 has a light penetration axis T1 substantially parallel to the first absorption axis X1 of the first polarizer 110 and the second absorption axis X2 of the second polarizer 210. If the optical film 412 is a reflective polarizer brightness enhancement film, the light penetration axis T4 of the optical film 412 is substantially parallel to the first absorption axis X1 and the second absorption axis X2.

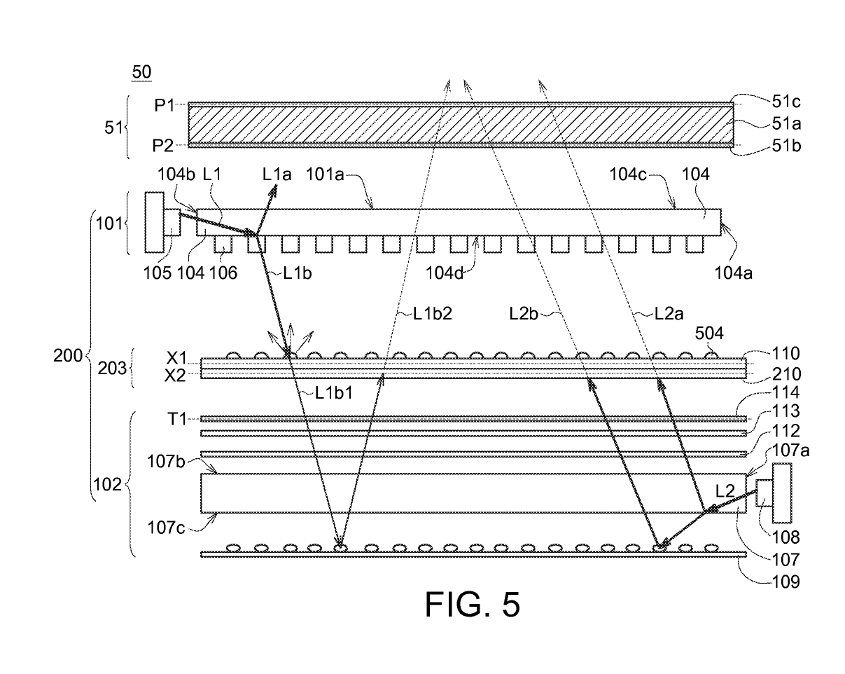

The aforementioned back light module, such as the back light module 200, can be integrated with a display panel to form a 2D/3D switchable display apparatus. Referring to FIG. 5, FIG. 5 is a cross-sectional view illustrating the structure of a display apparatus 50 according to an embodiment of the invention. The display apparatus 50 includes a display panel 51 and the back light module 200 of FIG. 2A. The display panel 51 can be realized by a liquid crystal display panel or other suitable display medium. In the present embodiment, the display panel 51, realized by a liquid crystal display panel, includes a liquid crystal layer 51a, two substrates (not illustrated) respectively disposed on the upper side and the lower side of the liquid crystal layer 51a, a lower polarizer 51b and an upper polarizer 51c disposed at opposite side of the lower polarizer 51b. The lower polarizer 51b and the upper polarizer 51c respectively have a first polarization axis P1 and a second polarization axis P2 orthogonal to each other. The light output surface 101a of the first light emitting module 101 (i.e. the first side surface 104c of the light guide plate) faces to the lower polarizer 51b of the display panel 51. The first absorption axis X1 of the first polarizer 110 and the second absorption axis X2 of the second polarizer 210 are substantially parallel to the first polarization axis P1 of the lower polarizer 51b.

When the display apparatus 50 is switched to display a 3D image, the light emitting unit 108 of the second light emitting module 102 can be turned off, and the light is provided by the light emitting unit 105 of the first light emitting module 101 only. Most of the light L1 emitted from the light emitting unit 105 and entering into the light guide plate 104 that is designated as L1a may be guided by the light guide elements 106 to form an alternating pattern of light and shade exited via the light output surface 101a of the first light emitting module 101 (i.e. the first side 104c of the light guide plate) and outputted toward the display panel 51. Then, a left-eye image formed by a part of pixels (not illustrated) of the display panel 51 is transmitted to the user's left eye, and a right-eye image formed by the other part of pixels (not illustrated) of the display panel 51 is transmitted to the user's right eye. Since the user's two eyes respectively receive two images having binocular parallax, the user can perceive a 3D image without wearing auxiliary eyeglasses.

The other part of the light L1 emitted from the light emitting unit 105 and entering into the light guide plate 104 that is designated as L1b may be guided to be exited via the second side surface 104d of the light guide plate 104 and outputted towards the attenuator 203. Since the light L1b is a non-polarized light, thus only a part of the light L1b, such as the polarized light L1b1 parallel to the first absorption axis X1 of the first polarizer 110 and the second polarizer 210 and the second absorption axis X2, can pass through the attenuator 203. In the present embodiment, both the first polarizer 110 and the second polarizer 210 of the attenuator 203 have a light transmittance substantially between 40% and 50%. Therefore, after the polarized light L1b1 passes through the attenuator 203 to be outputted to the second light emitting module 102, the intensity of the polarized light L1b1 will decay by about 50%. After the polarized light L1b1 outputted to the second light emitting module 102 is reflected and scattered by the diffuser 112, the brightness enhancement film 113, the reflective polarizer brightness enhancement film 114, and the light guide plate 107 and the reflector 109 of the second light emitting module 102, the polarizing state of most of the light L1b1 will be changed. Therefore, when the light is again outputted to the attenuator 203, only the part of the polarized light L1b2 still parallel to the first absorption axis X1 of the first polarizer 110 and the second absorption axis X2 of the second polarizer 210 will pass through the attenuator 203. In other words, the intensity of the light will again decay by at least 50%. Therefore, when the light L1b emitted from the light emitting unit 105 is again reflected by the second light emitting module 102 and then passes through the light output surface 101a, the intensity of the light L1b2 can be greatly reduced by the arrangement of the attenuator 203, thus the light L1b that is not directly outputted from the light output surface 101a of the first light emitting module 101 will not form unexpected images with an alternating pattern of light and shade on the display panel 51 or directly crosstalk with the 3D image passing through the light output surface 101a. As the result, the 3D image display quality of the display apparatus 50 will be increased.

In some embodiments of the invention, preferably a surface treatment is performed on one surface of the attenuator 203 facing to the light output surface 101a of the first light emitting module 101 (i.e. the upper surface of the first base layer 110a) to form at least one surface treatment structure 504 on the light output surface 101a. The surface treatment structure 504 may include at least one protrusion, at least one rib, at least one slot, at least one opening, at least one recess or one of the arbitrary combinations thereof. Since the light L1b outputted towards the second light emitting module 102 can be scattered by the surface treatment structure 504, thus the light L1b can be prevented from being directly reflected by the attenuator 203 and then passing through the light output surface 101a to generate an unexpected images having an alternating pattern of light and shade on the display panel 51, hence the occurrence of moirés can be reduced. In some other embodiments of the invention, the surface treatment structure 504 (not illustrated) can be selectively formed on the surface of the attenuator 203 facing to the second light emitting module 102 (i.e. the lower surface of the fourth base layer 210b).

When the display apparatus 50 is switched to display a 2D image, the light emitting unit 105 of the first light emitting module 101 can be turned off, and the light is provided by the light emitting unit 108 of the second light emitting module 102 only. Most of the light L 2 emitted from the light emitting unit 108 and entering into the light guide plate 107 that is designated as L2a may directly pass through the diffuser 112, the brightness enhancement film 113, the reflective polarizer brightness enhancement film 114, the attenuator 203 and the first light emitting module 101. The other part of the light L2 that is designated as L2b is firstly reflected by the reflector 109 and then passes through the second light emitting module 102, the diffuser 112, the brightness enhancement film 113, the reflective polarizer brightness enhancement film 114, the attenuator 203 and the first light emitting module 101, so as to form a polarized light L2c having one single polarizing state exited via the light output surface 101a of the first light emitting module 101 (i.e. the first side surface 104c). As a result, the 2D images can be outputted from the pixels (not illustrated) of the display panel 51 and transmitted to the user's two eyes.

Since the first absorption axis X1 of the first polarizer 110 and the second absorption axis X2 of the second polarizer 210 are substantially parallel to the first polarization axis P1 of the lower polarizer 51b, thus most of the polarized light L2c (90%˜98%) can pass through the lower polarizer 51b. In other words, the arrangement of the attenuator 203 has little influence on the actual light extraction rate of the second light emitting module 102. In order to compensate the light extraction rate of the second light emitting module 102, in some embodiments of the invention, when the display apparatus 50 display a 2D image, the light emitting unit 105 of the first light emitting module 101 is turned on at low or median power output state for assisting contribution.

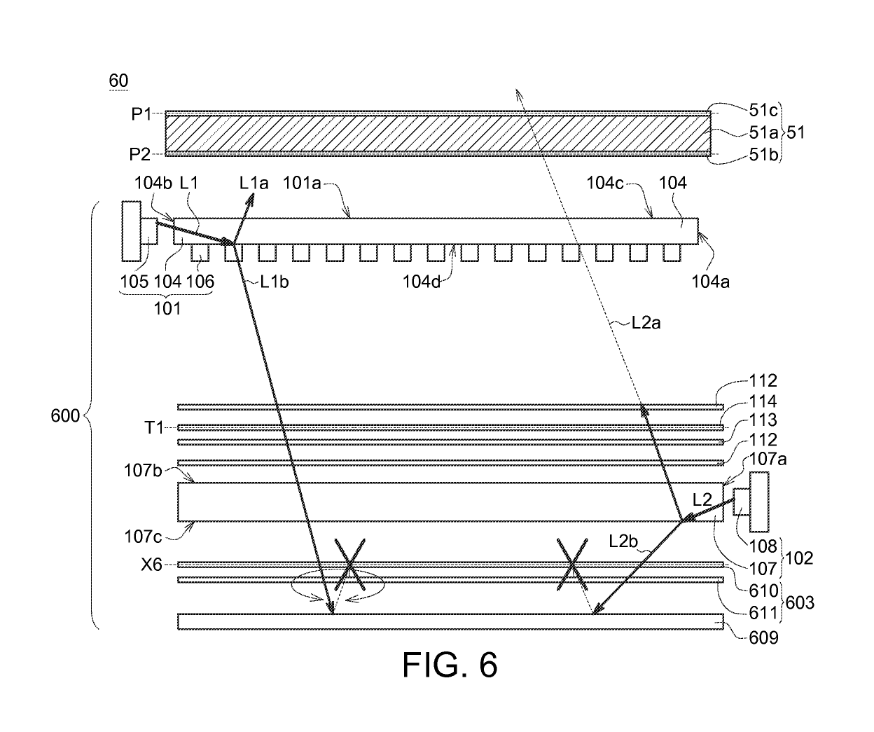

Referring to FIG. 6, FIG. 6 is a cross-sectional view illustrating the structure of a display apparatus 60 according to another embodiment of the invention is shown. Since the structure of the display apparatus 60 is similar to that of the display apparatus 50 as depicted in FIG. 5, descriptions of the elements common to the display apparatuses 50 and 60 are not redundantly repeated. The display apparatus 60 is different from the display apparatus 50 in the structure and disposition of the attenuator 603. In the present embodiment, the display apparatus 60 includes a display panel 51 and a back light module 600. The back light module 600 includes a first light emitting module 101, a reflector 609, a second light emitting module 102 and an attenuator 603. The first light emitting module 101 has a light output surface 101a facing to the display panel 51. The reflector 609 is disposed on a surface of the first light emitting module 101 opposite to the light output surface 101a. The second light emitting module 102 is disposed between the first light emitting module 101 and the reflector 609. The attenuator 603 includes a polarizer 610 and a retardation plate 611. The polarizer 610 has an absorption axis X6, and is disposed between the second light emitting module 102 and the reflector 609. The retardation plate 611 is disposed between the polarizer 610 and the reflector 609. In some embodiments of the invention, the reflector 609 preferably is realized by a mirror reflector. The retardation plate 611 can be realized by a quarter (λ/4) wave-plate.

When the display apparatus 60 is switched to display a 3D image, the light emitting unit 108 of the second light emitting module 102 and the light emitting unit 108 of the second light emitting module 102 can be turned off, and the light is provided by the light emitting unit 105 of the first light emitting module only. Most of the light L1 emitted from the light emitting unit 105 and entering into the light guide plate 104 that is designated as L1a is guided by the light guide elements 106 to form an alternating pattern of light and shade exited via the light output surface 101a of the first light emitting module 101 (i.e. the first side surface 104c of the light guide plate) and outputted towards the display panel 51. Then, a left-eye image formed by a part of pixels (not illustrated) of the display panel 51 is transmitted to the user's left eye, and a right-eye image formed by the other part of pixels (not illustrated) of the display panel 51 is transmitted to the user's right eye. Since the user's two eyes respectively receive images having binocular parallax, the user can perceive a 3D image.

The other part of the light L1 emitted from the light emitting unit 105 and entering the light guide plate 104, that is designated as L1b may be guided to be exited via the second side surface 104d of the light guide plate 104 and outputted towards the second light emitting module 102 and then pass through the second light emitting module 102 and the attenuator 603. Since the light L1b is a non-polarized light, thus only part of the light parallel to the absorption axis X6 of the polarizer 610 can pass through the attenuator 603. In the present embodiment, only the polarized light L1b1 can pass through the attenuator 603, and after the polarized light L1b1 passes through the attenuator 603, the intensity of the polarized light L1b1 will decay by about 50%. The polarized light L1b1 is then outputted to and passes through the retardation plate 611, and a phase difference of a quarter wavelength (λ/4) is thus created. When the polarized light L1b1 is mirror-reflected by the reflector 609, the polarized light L1b1 may be blocked by the polarizer 610 due to the change in the polarizing state and cannot again pass through the second light emitting module 102, the diffuser 112, the brightness enhancement film 113, the reflective polarizer brightness enhancement film 114 and the first light emitting module 101 to be exited via the light output surface 101a. Therefore, no unexpected images with an alternating pattern of light and shade will be formed on the display panel 51 to crosstalk with the 3D images provided by the display apparatus 60. As the result, the 3D image display quality of the display apparatus 60 will be increased.

When the display apparatus 60 is switched to display a 2D image, the light emitting unit 108 of the first light emitting module 101 is turned off, and the light is provided by the light emitting unit 105 of the second light emitting module only. Most of the light emitted from the light L2 of the light emitting unit 105 and entering into the light guide plate 107, a major part of the light L2 that is designated as L2a may directly pass through the diffuser 112, the brightness enhancement film 113, the reflective polarizer brightness enhancement film 114 and the first light emitting module 101. Thereby, 2D images can be outputted from the pixels (not illustrated) of the display panel 51 and transmitted to the user's two eyes. The other part of the light L2 emitted from the light emitting unit 105 and entering the light guide plate 107 that is designated as L2b may firstly pass through the attenuator 603 and then be mirror reflected by the reflector 609 to be exited via the light output surface 101a without passing through the second light emitting module 102 and the first light emitting module 101. In order to compensate the light extraction rate of the second light emitting module 102, in some embodiments of the invention, when the display apparatus 50 display a 2D image, at least one part of the light emitting unit 105 of the first light emitting module 101 is turned on.

In accordance with the embodiments of the present description, a 2D/3D switchable display apparatus and a back light module thereof are provided. In some embodiments of the invention, the back light module of the display apparatus at least includes a first light emitting module and a second light emitting module disposed in parallel. By switching between the first light emitting module and the second light emitting module, at least a 2D display mode and a 3D display mode can be provided to allow the users perceiving either 2D images or 3D images from the 2D/3D switchable display apparatus. The first light emitting module has a light output surface, and an attenuator having at least one absorption polarizer is disposed on one side of the first light emitting module opposite to the light output surface. The attenuator can prevent a small part of the light that is emitted from the first light emitting module and towards the second light emitting module from being reflected by the second light emitting module and forming unexpected moirés having a staggered arrangement of bright and dark stripes, so as to avoid the small part of the light crosstalking with the major part of light that is emitted from the first light emitting module and directly passing through the light output surface. Thus, the display quality of the display apparatus can be improved when the first light emitting module is enabled, and the display quality of the display apparatus may not be affected when switched to another display mode.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A back light module, comprising:
a first light emitting module having a light output surface;
a second light emitting module disposed on one side of the first light emitting module opposite to the light output surface; and
an attenuator disposed between the first light emitting module and the second light emitting module;
wherein, the attenuator comprises a first polarizer having a first absorption axis.

2. The back light module according to claim 1, wherein the first light emitting module comprises:
a light guide plate having at least one light input surface, a first side surface, and a second side surface opposite to the first side surface;
at least one light emitting unit adjacent to the light input surface; and
a plurality of light guide elements disposed on at least one of the first side surface and the second side surface.

3. The back light module according to claim 1, wherein the first polarizer, comprising a first base layer, a second base layer and a polarizing layer interposed between the first base layer and the second base layer; the first base layer and the second base layer is formed of a material selected from a group consisting of triacetate cellulose (TAC), polymethylmethacrylate (PMMA), polyethylene terephthalate (PET) and the arbitrary combinations thereof; and the polarizing layer is formed of poly-vinyl alcohol (PVA).

4. The back light module according to claim 1, wherein the attenuator has a surface treatment structure disposed on a surface of the attenuator facing to the first light emitting module; the surface treatment structure is selected from a group consisting of at least one protrusion, at least one rib, at least one slot, at least one opening, at least one recess and the arbitrary combinations thereof.

5. The back light module according to claim 1, wherein the attenuator further comprises a second polarizer having a second absorption axis substantially parallel to the first absorption axis; and the second polarizer is disposed between one of the first and second light emitting modules and the first polarizer.

6. The back light module according to claim 1, wherein the attenuator further comprises at least one optical film disposed between one of the first and second light emitting modules and the first polarizer; and the at least one optical film is selected from a group consisting of a diffuser, a brightness enhancement film, a reflective polarizer brightness enhancement film and the arbitrary combinations thereof.

7. The back light module according to claim 6, wherein the at least one optical film is a reflective polarizer brightness enhancement film, and has a light penetration axis substantially parallel to the first absorption axis.

8. A display apparatus, comprising:
a display panel comprising a lower polarizer having a first polarization axis, and an upper polarizer having a second polarization axis; and
a back light module, comprising:
a first light emitting module having a light output surface facing to the lower polarizer;
a second light emitting module disposed on one side of the first light emitting module opposite to the light output surface; and
an attenuator disposed between the first light emitting module and the second light emitting module, and comprising a first polarizer having a first absorption axis;
wherein the first polarization axis and the second polarization axis are substantially orthogonal to each other, and the first absorption axis of the first polarizer is substantially parallel to the first polarization axis of the lower polarizer.

9. The display apparatus according to claim 8, wherein the first light emitting module comprises:
a light guide plate having at least one light input surface, a first side surface and a second side surface opposite to the first side surface;
at least one light emitting unit adjacent to the light input surface; and
a plurality of light guide elements disposed on at least one of the first side surface and the second side surface.

10. The display apparatus according to claim 8, wherein the first polarizer comprises a first base layer, a second base layer and a polarizing layer interposed between the first base layer and the second base layer; the first base layer and the second base layer is formed of a material selected from a group consisting of TAC, PMMA, PET and a combination thereof; and the polarizing layer is formed of PVA

11. The display apparatus according to claim 8, wherein the attenuator has a surface treatment structure disposed on a surface of the attenuator facing to the first light emitting module; the surface treatment structure is selected from a group composed of at least one protrusion, at least one rib, at least one slot, at least one opening, at least one recess and a combination thereof.

12. The display apparatus according to claim 8, wherein the attenuator further comprises a second polarizer having a second absorption axis substantially parallel to the first absorption axis; and the second polarizer is disposed between one of the first and second light emitting modules and the first polarizer.

13. The display apparatus according to claim 8, wherein the attenuator further comprises at least one optical film disposed between one of the first and second light emitting modules and the first polarizer; and the at least one optical film is selected from a group consisting of a diffuser, a brightness enhancement film, a reflective polarizer brightness enhancement film and the arbitrary combinations thereof.

14. The display apparatus according to claim 13, wherein the at least one optical film is a reflective polarizer brightness enhancement film, and has a light penetration axis substantially parallel to the first absorption axis.

15. A display apparatus, comprising:
a display panel; and
a back light module, comprising:
a first light emitting module having a light output surface facing to the display panel;
a reflector disposed on one side of the first light emitting module opposite to the light output surface;
a second light emitting module disposed between the first light emitting module and the reflector; and
an attenuator, comprising:
a polarizer having an absorption axis and disposed between the second light emitting module and the reflector; and
a retardation plate disposed between the polarizer and the reflector.

16. The display apparatus according to claim 15, wherein the first light emitting module comprises:
a light guide plate having at least one light input surface, a first side surface and a second side surface opposite to the first side surface;
at least one light emitting unit adjacent to the light input surface; and
a plurality of light guide elements disposed on at least one of the first side surface and the second side surface.

17. The display apparatus according to claim 15, further comprising at least one optical film disposed between the first light emitting module and the second light emitting module; and the at least one optical film is selected from a group consisting of a diffuser, a brightness enhancement film, a reflective polarizer brightness enhancement film and the arbitrary combinations thereof.
